(19) United States
(12) Patent Application Publication
(10) Pub. No.: US 2005/0269821 A1
(43) Pub. Date: Dec. 8, 2005

(54) Hydro-generator

(76) Inventor: Bernard A. Nadel, Irvington, VA (US)

Correspondence Address: Bernard A. Nadel, PO Box 499, Irvington, VA, 22480, US

(21) Appl. No.: 10/860,215

(22) Filed: Jun. 4, 2004

(51) Int. Cl. H02P 9/04; F03B 13/10; F03B 13/12

(52) U.S. Cl. 290/1 R

(57) ABSTRACT

A system of weights, fulcrums and gears are actuated by any rocking motion to transform this motion into rotary motion. Continuous, accelerated rotation is achieved by the use of unidirectional gears to take advantage of every up or down movement. The R.P.Ms are then increased via free wheeling gearing to a point appropriate to the production of D.C. current via a generator. Two wires, an anode and a cathode from the generator, are immersed in salt water. Hydrogen and oxygen is then propagated by breaking down water (H2O) by electrolysis which is accumulated and respectively pumped to a larger storage facility. The HYDRO-GENERATOR works best when placed on a raft where wave action supplies both the energy and the salt water. A large HYDRO-GENERATOR on a large raft, appropriately located, should continuously produce an enormous quantity of gas continuously, indefinitely, economically and ergonomically. A small HYDRO-GENERATOR could also be used on a boat as a trickle charger to maintain battery power.

### CROSS REFERENCE

None found.

### BACKGROUND OF INVENTION

This invention relates to the propagation of hydrogen without pollution of any kind in the process (as in the past) via a device that translates the slightest motion, generally but not specifically, sea waves and converts that motion into Hydrogen with Oxygen as a by product

### DESCRIPTION

The attached pages illustrate and give a description of the invention.

### BRIEF SUMMARY

The device described and illustrated herein is the preferred embodiment of the invention. The HYDRO-GENERATOR may be made of diverse materials herein described or a combination of two or more materials. The incentive concept of the device encompasses the method of use i.e. the translation of random, rocking, motion into rotary motion, hence into electricity, and hence into Hydrogen and Oxygen via electrolysis by converting salt water and particularly sea water, into it's component parts and collecting and pumping them to a storage facility. The energy to activate the device would preferably but not necessarily be, sea wave action, in which case the device would be placed on a raft or other floating object.

### DETAILED DESCRIPTION OF THE INVENTION

The main concept of the invention: When the Hydro-Generator is activated, as by sea waves, a teeter totter is set into a see saw motion which lowers and raises balance weights hung near the extremities of the teeter totter. This motion is intensified and strengthened by the weights; Then through a series of chain arms, levers and one way gears, motion becomes rotary and is accelerated. The gears are equipped with one way bearings and arranged so that there is virtually no lost motion. Both up and down movements of the weights add momentum to a heavy bull gear. The bull gear is equipped with a departure bearing similar to the gears in the rear bycicle wheel and is free wheeling which tends to maintain a steady rotation that runs a generator which in turn produces DC current. Two wires, an anode and a cathode from the generator are immersed into a tank containing brine from the sea where DC current is used to break down an endless supply of salt water into it's component parts. Oxygen and Hydrogen by electrolysis. The gas is accumulated and pumped to a storage facility. The pump is also operated by the motion of the sea. A smaller version of the HYDRO-GENERATOR could be used on a boat as a trickle charger. Heretofore, other hydrogen propogators have required the use of engines that produce their own pollution. HYDRO-GENERATOR uses only the waves of which there is an unending supply.

On page 5 Hydro-Generator is delineated as follows:

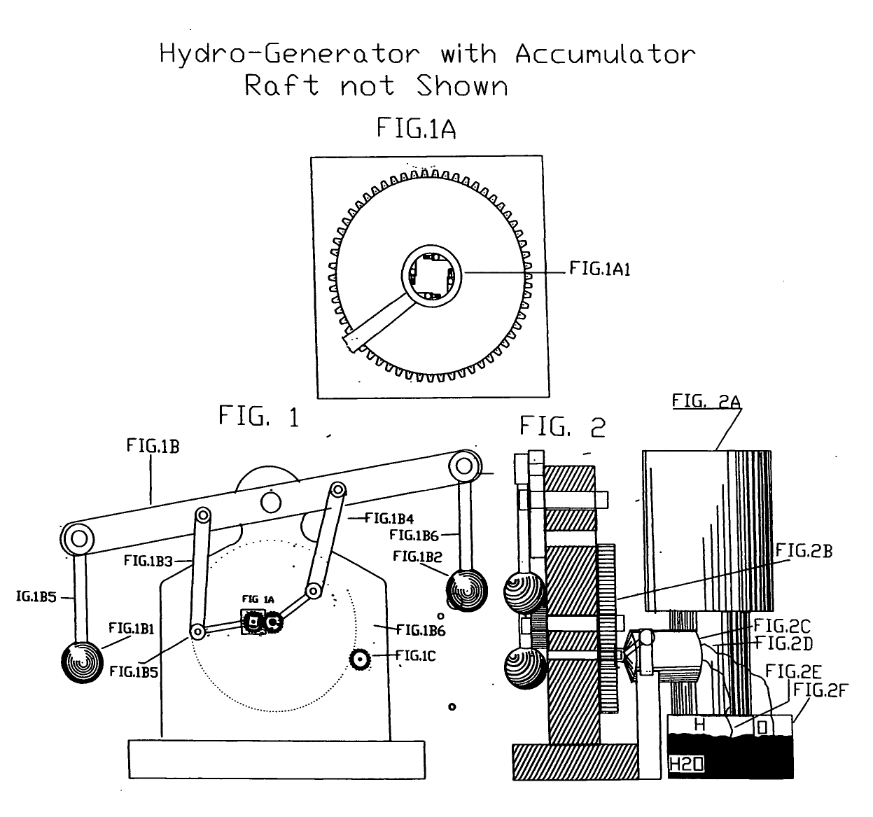

FIG. 1 Is a front view of the HYDRO-GENERATOR. Generator.

FIG. 1B is the teeter totter.

FIG. 1A1 is an enlarged inset of one of the departure (one way) gears. illustrated in FIG. 1A. FIGS. 1B3 and 1B4 are chain arms. FIGS. 1B1 and 1B2 are balance weights. FIG. 1C is the generator gear.

FIG. 2 is a side view and cross section of the HYDRO-GENERATOR illustrating, bull gear 2B, generator 2C, accumulator 2A and salt water basin 2F. FIGS. 2D and 2E are Anode and Cathode wires.

All are self explanatory to one skilled in the art.

1. I claim inventive rights to a device that produces electricity by converting any slight rocking motion such as sea waves into accelerated, rotary, free wheeling motion and hence into electricity without the use of pollution producing devices.

2. I claim inventive rights to the propagation of Hydrogen and Oxygen from the sea by the translation of wave action into electricity and hence via electrolysis. without the use of pollution producing engines.
